(19) United States
(12) Patent Application Publication
(10) Pub. No.: US 2006/0222263 A1
(43) Pub. Date: Oct. 5, 2006

(54) Linear measurement machine-readable medium, method and system

(76) Inventor: Eric A. Carlson, La Mesa, CA (US)

Correspondence Address: Gary M. Nath;NATH & ASSOCIATES, PLLC, 112 South West Street, Alexandria, VA, 22314-2891, US

(21) Appl. No.: 11/396,679

(22) Filed: Apr. 4, 2006

Related U.S. Application Data
(60) Provisional application No. 60/667,235, filed on Apr. 4, 2005.

(51) Int. Cl. G06K 9/36

(52) U.S. Cl. 382/287

(57) ABSTRACT

Linear measurements of items are made by selecting a field of view including the items. A reference marker of known length is placed in the field of view. A digital image of which is taken and stored. Digital image information is processed by a program, and with the reference marker is resolved in the image. A user may locate a cursor at an end of the reference marker and click to register the position. An electronic distance, e.g., a number of pixels between the ends of the reference marker, is normalized to the length of the reference marker. A user selects points on the image on a display to define a line segment on a dimension of interest to be determined. Calculations relate the length of the line segment to the length of the reference marker. A number indicated the desired dimension may be displayed on the image.

### CROSS REFERENCE TO RELATED APPLICATIONS

The present application claims priority of U.S. Provisional Patent Application Ser. No. 60/667,235 filed Apr. 4, 2005, which is incorporated by reference herein in its entirety.

### FIELD OF THE INVENTION

The present subject matter relates generally to a linear measurement system to replace measuring with a tape measure or the like in a which a field of view is established and measurements are made on an image comprehending the field of view.

### BACKGROUND OF THE INVENTION

An important use of linear measuring is the measurement of objects surrounding us in our daily lives. These objects may include buildings, other structures, vehicles and subunits and components thereof. A new and expanding area requiring measurement has been enabled by the advent of large scale graphics. Signs and surfaces for wrapping objects are being produced in sizes that are unprecedented. One new form of large scale graphics is called the digital wrap. A surface is produced which may have decorations, advertising copy, images or other indicia printed thereon. The surface is wrapped on a substrate generally intended to be widely viewed. For example, digital wrap is now being used on mass transit buses. The use of digital wrap replaces painting. Digital wrap provides a wide range of graphic options not available with paint; it can be applied in an efficient manner and can be easily removed and replaced.

The bus becomes the canvas of the graphic artist. To arrange graphic matter on the surface, the graphic designer must know where on the vehicle, or other substrate, particular graphic matter will appear. Many measurements of the bus must be taken, including a front grille, front windows, side windows, side panels. The graphic artist cannot rely on dimensions on blueprints produced by the manufacturer of the bus. The drawings may be unavailable or they may be out of date. Even if the graphic artist can obtain the drawings, it is still prudent to take measurements. Commonly, if there is a discrepancy between the drawings and actual bus dimensions, the graphic artist will bear any loss due to the discrepancy. It is not practical to measure every nook and cranny of a bus. An optimization must be made of expense of gathering a measurement likelihood that it will be needed. After measurement data is collected and taken back to the graphic artist's shop. If it is becomes necessary to know the value of a dimension that was not taken, a person doing the measuring must return to the site where the object is. Having to take further measurements costs both time and money. Exposures to hazards, if any, during measurement must be risked an additional time.

Traditional examples, of linear measurement include insurance adjusters recording sizes of cars and lengths of skid marks. Real estate agents will measure sides and perimeters of houses and lots as well as measure dimensions of rooms. Construction estimators will measure various components of a job site. Even with the advent of the digital age, it is currently standard practice for such professionals to have to drive or otherwise travel to a site and make measurements manually. An article in Realty Times directed to professionals and appearing at http://realtytimes.com/rtcpages/20040916_buyingtools.htm recommends a list of essential tools, “If you are the typical homeowner, or a real estate agent who deals with those folks . . . [A] must is a tape measure. Get one that is made of steel and has a tape that's 25 feet long.”

A sign of entry into the high tech age is the production of products including the ultrasonic Pocket Dimension Master and the Laser Dimension Master by Calculated Industries, Inc. of Reno, Nev. Their advertisements address, “Real Estate Agents/Brokers, Contractors/Builders, Interior Designers, Remodelers, [and] Estimators . . . ” among others. They recognize the prevalence of manual measurement in their advertisement copy stating, “Forget the cumbersome tape measure! Use the Pocket [or Laser] Dimension Master to measure interior distances with the press of a button! Just aim & shoot to get an instant digital readout.” Even if a professional utilizes this apparatus to avoid the physical requirements of using a tape measure, he or she must still travel to a site at which measurements are to be made.

Apparatus for making measurements from an image or a sighting have been provided in the past. Such apparatus does not meet the needs of users such as those described above. A number of parameters must be measured, not allowing establishment of a dimension simply by taking a linear measurement. The complexity of such apparatus does not lend itself to low-cost manufacture or ease of transporting the apparatus. For example, U.S. Pat. No. 2,616,177 discloses a surveying apparatus in which a photographic of elevations of a terrain is taken, and a rod having upper and lower targets at predetermined spaced distances is included in the photograph to provide a reference distance. In making calculations based on the photograph, the distance to the rod from the camera must be known as well as the focal length of the camera lens.

U.S. Pat. No. 4,670,659 discloses a calibration method for an optical measuring system. An electro-optical measurement measures the width of a strip being rolled. The strip is imaged onto a first and a second electro-optical transducer, each of which views the whole width of the strip. To compensate for inaccuracies resulting from the imaging system, a calibration of the imaging system is effected by means of a grid of known dimensions. The calibration results are recorded during a setting up process and used by a digital or analog computer to correct any measurements taken by the imaging system during operation. This system requires the use of two cameras which must be maintained in a fixed relationship to one another. The patent contemplates a preferred embodiment in which the cameras are on the order of meters from the roll. Positioning cameras to image a house could be unwieldy.

U.S. Pat. No. 5,073,819 discloses a method of using a computer to assist a land based video survey. Initially, a video recording of a control location and a survey area is produced. The control location video includes at least a view of a baseline scale. Further, camera position data associated with the control location is stored. The computer converts the baseline scale from the control location video image to a video image scale. A survey video frame image of interest is selected and is displayed. A point of interest on the survey video frame is identified along with a predetermined baseline point obtained from a baseline scale image view overlaid on the survey video frame. In one embodiment, this identification step is conducted manually by an operator touching a touch sensitive pad having fine grid lines corresponding to pixel points in the video frame image. The distance between two identified points is calculated based upon the video image scale and the camera position data. However, this calculation cannot be done without knowing a distance from a camera to a target. Successive video frames must be compared.

U.S. Pat. No. 6,359,644 discloses a remote visual inspection device measurement system for medical use comprising a lens system having selected optical characteristics and a CCD imager. The system includes a video display and an image overlay generator to select the target object in the video display. The image overlay generator allows the operator to mark the image and determines the number of pixels between cursor marks. The system includes a focusing mechanism including a focus motor with a servo feedback that provides focus data and a zoom mechanism including a zoom motor with a servo feedback that provides zoom data. The system includes a microprocessor/CPU that calculates the size of the target object by mathematically manipulating the optical characteristics, the focus data, the zoom data, and the pixel data. Again, the zoom data must be known. Additional expense is entailed in the production of this unit since it must include an autofocus system.

The above-described systems do not provide an alternative to measuring tapes that is both cost-effective for a small business and simple to use. Additionally, these prior art systems are intended to be employed where the processing apparatus is located at the same site where the measurements are calculated. The problem of having to travel to a remote site in order to get data from which a first-hand mathematical result can be calculated is not solved.

### SUMMARY OF THE INVENTION

Briefly stated, in accordance with an embodiment of the present invention, linear measurements are made of items by selecting a field of view including the items. A reference marker having a predetermined length, e.g., a yardstick or meter stick, is placed in the field of view. A digital image of the field of view is generated and stored, for example in a digital camera. Digital information indicative of the image may be sent over a network for processing or transported physically to a workstation in a medium. A user may view the image on a display. A program is provided in which the reference marker is resolved in the image, and an electronic length, e.g., a number of pixels between the ends of the reference marker, is normalized to the length of the reference marker. To find a desired dimension, a user selects points on the digital image on a display to define a line segment on the image corresponding to a dimension of interest to be determined. The location of the points may be registered by clicking on a mouse, for example. The processor utilizes data indicative of the positions of the points to relate the length of the line segment to the length of the reference marker, and a number indicative of the desired dimension is generated. The number is provided to one or more output means. The output means may be a display, a digital data form or other means for receiving data.

### BRIEF DESCRIPTION OF THE DRAWINGS

FIG. 1 is a perspective view of an embodiment of the present invention interacting in an operational environment;

FIGS. 2 and 3 are perspective views of reference objects that may be used in the application illustrated in FIG. 1;

FIG. 4 is a perspective view of an arrangement in which differences due to perspective in the apparent dimension of surfaces at varying distances from the digital camera are accounted for;

FIG. 5 is a block diagram illustrating transmission of data from a measurement location to a remote location for processing and one form of data processing means;

FIG. 6 is an illustration of a graphical user interface for use in conjunction with the present embodiment;

FIGS. 7-10 are each a plan view illustrating one form of operation of an embodiment of the present invention;

FIG. 11, consisting of FIGS. 11A and 11B, is a flow chart illustrating the operation of the embodiment of FIGS. 6-10; and

FIG. 12 is a flow illustrating operation of a further embodiment.

### DETAILED DESCRIPTION

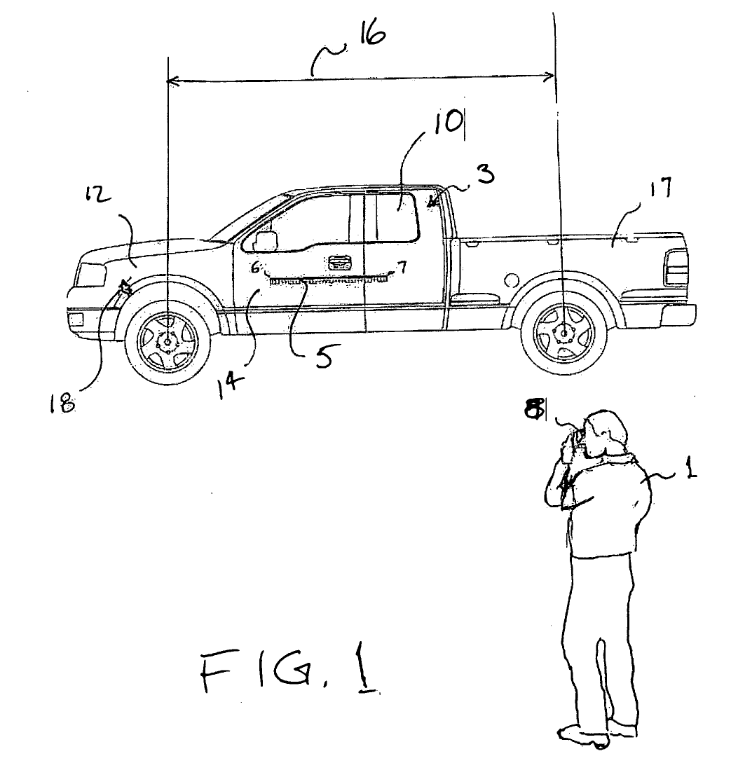

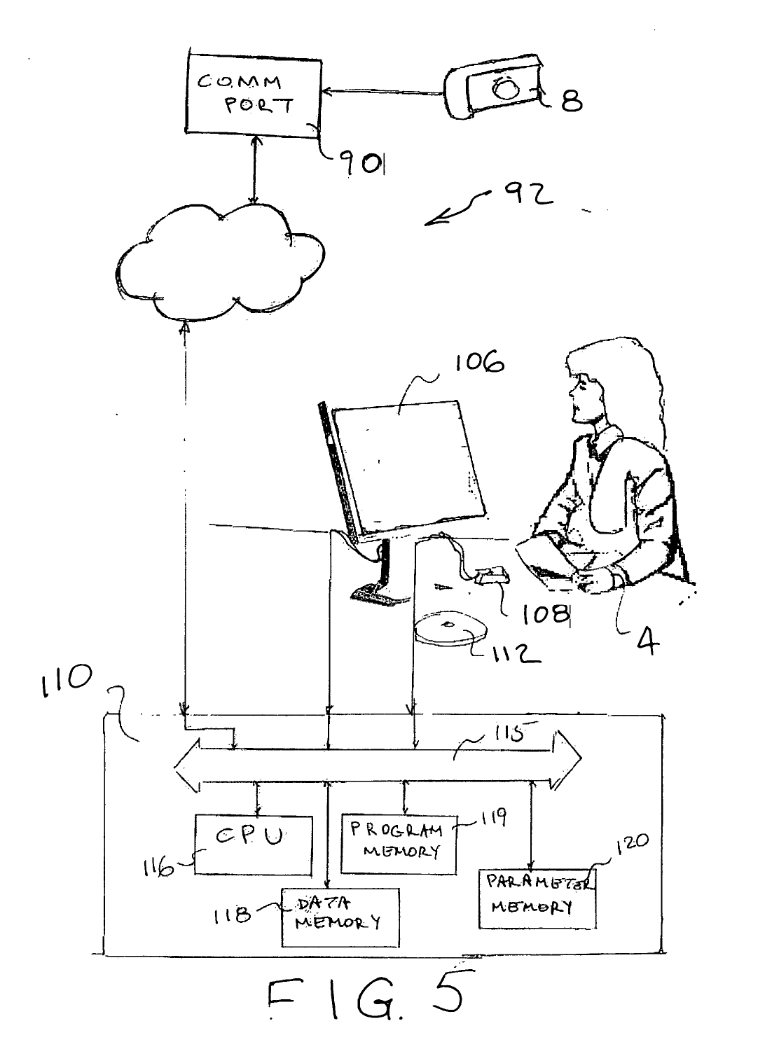

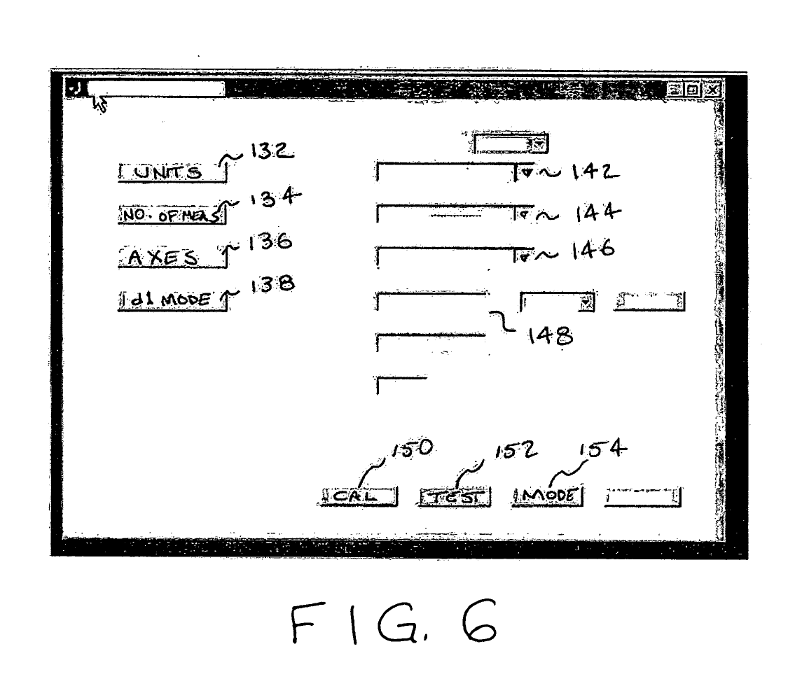

FIG. 1 is a perspective view of an embodiment of the present invention interacting in an operational environment. In the present illustration, a field user 1 is measuring dimensions of an object 3. The field user 1 will provide data to a base user 4 (FIG. 5) who will derive desired measurements from collected data. The field user 1 may be the same person as the base user. The base user 4 is generally a person who must have first hand knowledge of the characteristics and who is unable or unwilling, whether for reasons of reliability or regulation to accept a list of measurements made by others or is a person who is required to provide the service of taking measurements. Currently, it is customary for real estate agents, insurance adjusters, appraisers or other base users to leave their offices to go to the site of the object 3 and take their own measurements. It is noteworthy that embodiments of the present invention allow the base user 4 to have another person to collect data at the site of the object 3 and allow the base user 4 to make his or her own first hand measurement calculations without having to go to the site of the object 3.

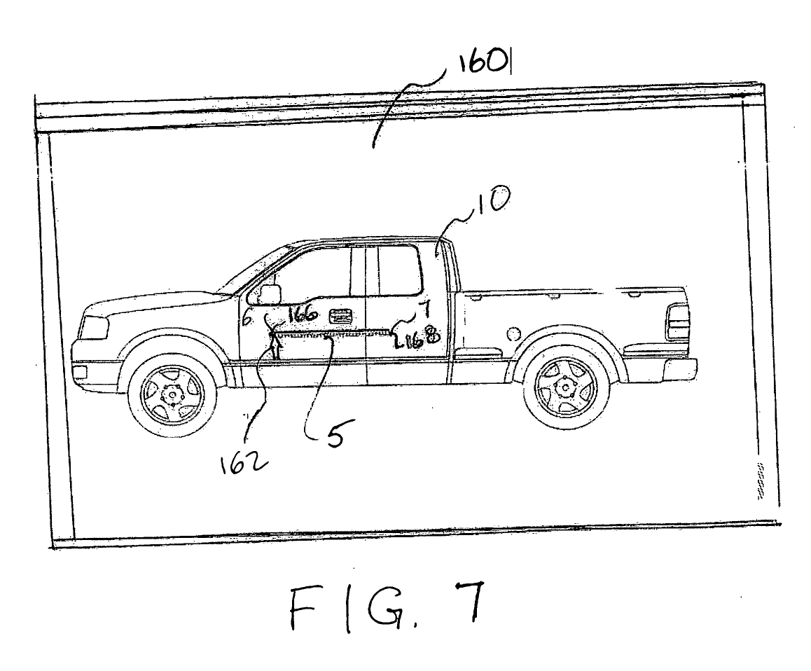

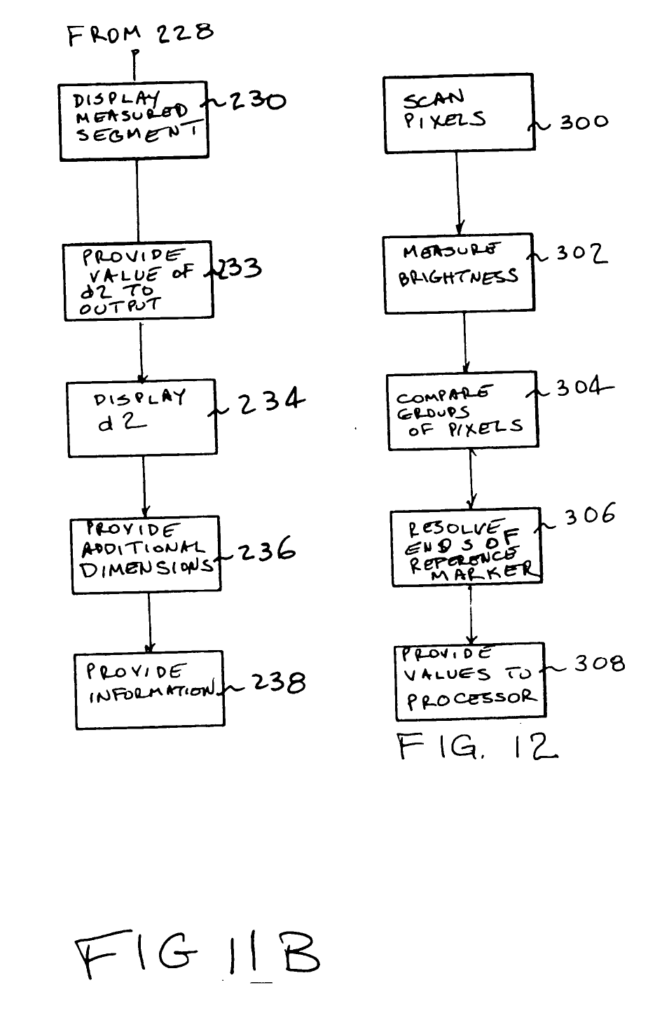

FIGS. 1-4 describe the collection and storage of image data. FIG. 5 illustrates a system for transmitting and processing the data. FIGS. 6-10 illustrate nominal computer screens that may be produced in a selected embodiment and how a user may interact with the screens. FIGS. 11 and 12 illustrate methods of image processing and the software performing the methods.

A reference marker 5, having first and second ends 6 and 7, is utilized as further described below. The reference marker 5 is most conveniently a linear ruler. In a nominal embodiment, the reference marker 5 may be one yard or one meter long. This dimension is useful for providing a length to which dimensions of commonly measured objects such as vehicles and houses may be compared. The reference marker may also be provided in larger or smaller sizes. For vehicle engines or selected portions of objects, the reference marker may be, for example, either 6 inches or 15 cm long.

The field user 1 gathers data indicative of an image of the reference marker, an image of the object 3 and their spatial relationship with a sensing and data collection device 8. For convenience in description, the sensing and data collection device 8 will be referred to as a digital camera 8. Many different types of hardware may be used to form and store an image in digital form and provide a storage means from which data can be conveniently accessed. At the present time, a digital camera is a very convenient means for performing the imaging and storage functions. However, at the present time, hardware to record and store images is evolving rapidly, and other means may come in to use.

In FIG. 1, the object 3 is a pickup truck 10. Among the many components that are commonly measured are the front quarter panel 12, door 14, wheelbase 16 and cargo compartment 17. Non-original features of the pickup truck 10 may include a dent 18. In order to gather data, the field user 1 will take a picture of the pickup truck 10 that includes the reference marker 5 and areas that are to be measured as well. It is possible that on some vehicles a surface of the cargo compartment 17 will not be coplanar with the door 14 on which the reference marker 5 is placed. Simple geometry may be used to calculate the amount of error introduced by any difference in distance from the pickup truck 10 between the digital camera 8 and the reference marker 5. The amount of error tolerable will vary with the application. In many foreseeable applications, this error will be negligible.

Generally, portions of the pickup truck 10 that will be measured are existing components with boundaries that are readily discernable when viewing an image thereof. For example, when it is desired to measure width of the door 14, edges of the door 14 will be apparent in an image. If for some reason, it is desired to measure distances between points that will not be readily discernable to a viewer of an image, markers such as 22 and 24 may be placed at selected point so they will appear in the image.

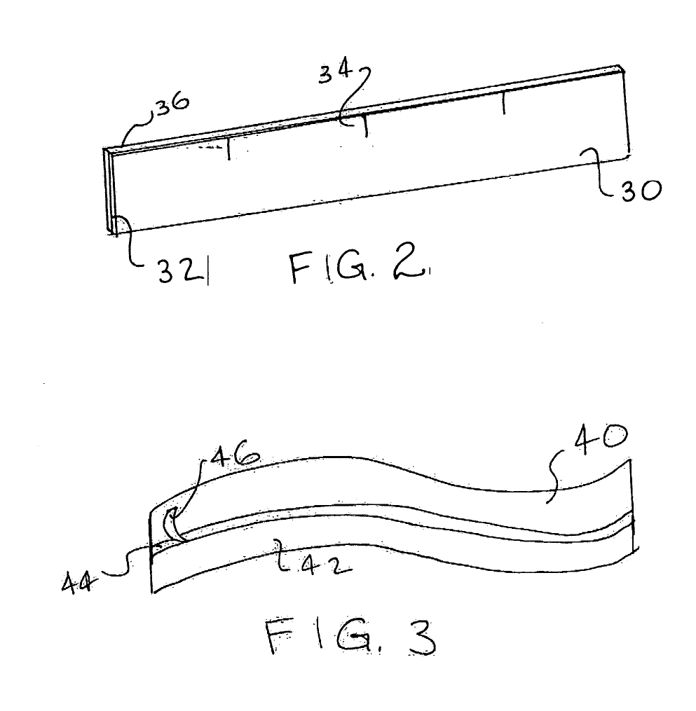

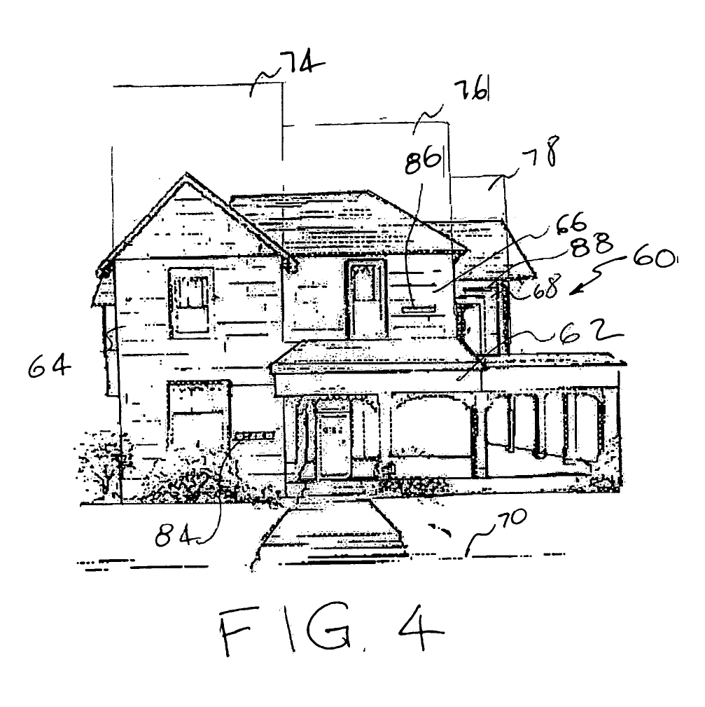

FIGS. 2 and 3 are perspective views of an obverse and a reverse respectively of first and second forms of reference markers 30 and 40 that may be used in the application illustrated in FIG. 1. The reference markers 30 and 40 each comprise an embodiment of the reference marker 5. The reference marker 5 may be made to have a predetermined width to which it will be convenient to compare other items in an image. Nominal widths are a yard or a meter. Gradations may be marked on the surface of the reference marker 5 to allow comparison to less than the entire length thereof. Gradations also permit the reference marker 5 to be used as a ruler.

In one form, a surface of the reference marker 5 facing the digital camera 8 is made to have a bright color. One suitable color is bright yellow. Bright yellow will stand out in most color images and also will generally be distinctive in gray scale images. It is desirable to make it easy for a base user 4 to select the reference marker 5 out of an image when determining lengths of objects in an image in the manner described below. Many cities have yellow buses and fire engines. Alternative colors may be preferred for measuring such objects. In a further form, the reference marker 5 may be made to include characteristics that facilitate resolution of the reference marker 5 in an electronically processed image. The characteristic will be a function of the particular image-processing algorithm utilized and may also be a function of the type of image detector in the digital camera 8 or particular optical or electronic filters. To this end, the reference marker 5 may be made with a surface of a particular color, be imprinted with codes such as bar codes or other codes or may include radiating components such as light emitting diodes.

As seen in FIG. 2, the reference marker 30 comprises an indicia layer 32 having distance gradations 34 marked thereon. The indicia layer 32 is fixed to a substrate layer 36. Alternatively, the reference marker 30 could comprise a single layer. The indicia layer 32 is preferably of an imprintable material to bear gradations or codes. The indicia layer 32 is also preferably weatherproof and durable, neither shrinks nor expands and may be made in a selected color. Many forms of plastic are available to meet these requirements. The substrate layer 36 may take many different forms. The substrate layer 36 could be a traditional solid wood or metal yardstick. In one form, the substrate layer 36 is magnetic so that the reference marker 30 can be removably secured to vehicle surfaces or other ferrous surfaces. Isotropic rubber magnets are available in rolls from many sources. Substrate layers 36 may be made by cutting a roll of isotropic rubber into selected lengths. Isotropic rubber is flexible. Therefore, the reference marker 30 may be rolled up after use for convenient storage, and will be more easily included in a package than a yardstick or a meter stick.

The reference marker 40 of FIG. 3 comprises a thin strip 42, which could comprise paper, cloth or vinyl, for example. The reference marker 40 is made to be adhesively secured to the object 3 (FIG. 1). An adhesive stripe 44 is formed on the reverse of the reference marker 40. The adhesive stripe 40 may extend the entire length of the reference marker 40. A peel strip 46 is placed over the adhesive strip 44. The peel strip 46 is preferably of conventional material that will readily peel from the adhesive stripe 44 when a user prepares to place the reference marker 40 on an object 3.

FIG. 4 is a perspective view of an arrangement in which differences due to perspective in the apparent dimension of surfaces at varying distances from the digital camera are accounted for. In FIG. 4, a multiplanar object 60 comprises a house 62. The house 62 includes a forwardly extending ell 64, a central section 66 and a rear section 68, each comprising one or more rooms. In this description, “forward” means toward or closer to a curb 70 at a street by which the house 62 is located. Each of the sections 64, 66 and 68 has a forward wall substantially coplanar with vertical planes 74, 76 and 78 respectively. In a photographic image, a selected distance on a surface of the house 60 will have a different dimension depending on which plane it is in. This effect is more pronounced when measuring dimensions on surfaces at different distances at a stadium or airport than when measuring at the house 62.

In order to eliminate the effect of distance from the digital camera 8, separate reference markers 84, 86 and 88 are utilized. The reference markers 84, 86 and 88 are placed on the walls in the planes 74, 76 and 78 respectively. When image processing and analysis is done, as further described with respect to FIGS. 6-11 below, the reference markers 84, 86 and 88 are used separately to provide a baseline for comparison for measurements.

FIG. 5 is a block diagram illustrating the production of desired measurements. The field user 1 and the base user 4 may be at separate locations. The digital camera 8 is interfaced to a communications port 90. The communications port 90 can be any device capable of taking image data from the digital camera 8 and transmitting the digital data from the digital camera 8 to a network 92. The network 92 could comprise the Internet, a wide area network (WAN), local area network (LAN) or other network. The communications port 90 may conveniently comprise a personal computer. The personal computer may download information for retransmission in accordance with a standard protocol. The digital image may be simply transmitted, for example, as an email attachment.

Alternatively, the digital data may be sent to a server 96 comprising a photo album website in which separate users are each allocated separate password-protected space. A user may establish a set of permissions for selected people to view the data. Separate computer accounts may be provided so that either the field user 1 or the base user 4 may specify one or more other users as being allowed to access the digital data. The field user 1 could be an independent contractor serving a number of base users 4. The field user 1 may allow each base user 4 to access a different set of images. The base user 4 could establish separate sets of permissions for clients or colleagues.

The base user 4 utilizes a digital measurement generator 102 within a workstation 104. The workstation 104 includes a monitor 106 and an image interaction device, here a mouse 108, and a processor 110, which may be housed in a conventional computer tower. The processor 110 and apparatus interacting therewith can respond to commands of a machine-readable medium. A machine-readable medium includes any mechanism that provides (i.e., stores and/or transmits) information in a form readable by a machine (e.g., a computer). For example, a machine-readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.) etc. The particular architecture illustrated of the digital measurement generator 102 is illustrative of the functions performed, and many alternatives may be provided. The discrete functional units of the digital measurement generator 102 may be embodied in a number of ways well known in the art to provide a described operation. For example, discrete memories are illustrated. However the various databases could comprise locations within a single memory unit.

The base user 4 may access software to perform processing of images from a medium such as a CD 112, may download a program or may utilize a hosted application service via the network 94. A data bus 115 provides an interface between the processor 110 and the network 94. A number of components described below interact via the data bus 115 in order to process an image. The particular arrangement and selection of components is representative of many ways to perform the recited functions. Components illustrated as discrete units may be included within other components. A central processing unit (CPU) 116 orders operations and performs calculations. A data memory 118 stores image data as well as calculated data produced in accordance with a program in a program memory 119. A separate parameter memory 120 is illustrated to indicate storage of factors used to relate image data to reference information.

FIG. 6 is an illustration of a graphical user interface 130 for use in conjunction with the present embodiment. Screen buttons are provided in accordance with the software used for processing further described below. In the present illustration, screen buttons 132, 134, 136 and 138 are provided respectively associated with drop down menus 142, 144, 146 and 148 respectively. Each button selects a data entry mode, and the drop down menus are used for entering values. Many other means for entering values could be provided in the alternative. The software may be written or modified to add screen buttons or provide fewer screen buttons.

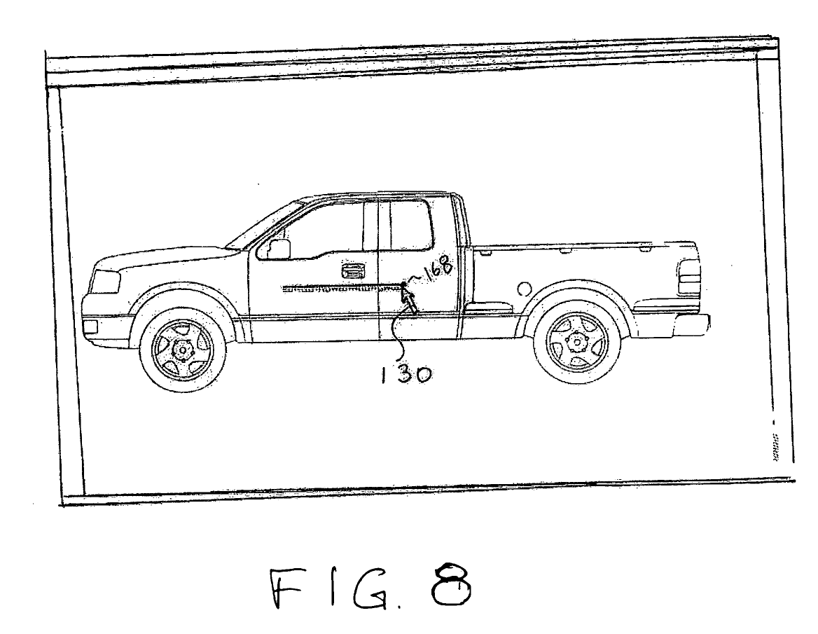

If an international edition of the software further described below is provided, a field 132 is provided to allow the user to select the type of units to be utilized. A drop down menu 142 may be used to provide an alternative for a user to select, such as whether English or metric units will be used. Screen button 134 may be used to enter number of measurements to be made. A drop down menu 144 may provide the user the ability to select whether the analysis will provide one value for a point-to-point distance within an image or whether separate X displacement and Y displacement values, or both will be provided. A second drop-down menu 145 may be provided for entering a length of the reference marker 5. Button 136 may command a mode for selecting whether the image is to be regarded as flat or whether a plurality of planes will each be calibrated, as for example in the illustration of FIG. 4. A drop down menu 146, the number of planes to be calibrated may be entered. Button 138 may command a mode for selecting whether the image is to be calibrated by the user, as illustrated in FIGS. 7-10, or automatically. At drop down menu 148, the selection is entered. Further buttons 150, 152 and 154 may be provided for selecting calibration mode, test mode and other modes in which such functions as data editing or tabulation may be performed.

FIGS. 7-10 are each a plan view of a computer screen displaying an image 160. FIGS. 7-10 illustrate actions performed by a base user 4. The base user 4 may enter input information from an image by the interaction described below in order to obtain measurements with respect to an object. FIG. 11 is a flow chart illustrating the operation of an embodiment in which the base user 4 interacts with the image 160 to provide the system with information indicative of reference markers, such as that of FIGS. 6-10. Data collection, transmission and processing and hardware and software functions are illustrated in FIG. 11. The steps described need not necessarily be performed in the order presented in the present illustration. For example, a dimension on an object may be taken in the manner described below before a reference marker image dimension is taken. However, order of steps may not be changed where a logical inconsistency would result.

As seen in FIG. 7, the base user 4 accesses data from the processor 110 (FIG. 5) in order to display a selected image 160 on the display 106. In the present illustration, the image 160 will comprise an image of the pickup truck 10 taken as described with respect to FIG. 1. The image of the reference marker 5 and its opposite end 6 and 7 appears on the pickup truck 10. The base user 4 will operate the mouse 108 to move a cursor 162 to establish an electronic length of the reference marker 5 which will comprise a reference with respect to which other lengths in the image 160 may be compared. Electronic length may be expressed in many ways. Prevalent types of display units 106 comprise pixel displays. In one common format, the image 160 will have a dimension of 1024×768 pixels. The base user 104 moves the mouse 108 to move the cursor 162 on the image 160. The mouse 108 provides a signal which will be translated in a manner described with respect to FIG. 11 to an indication of distance.

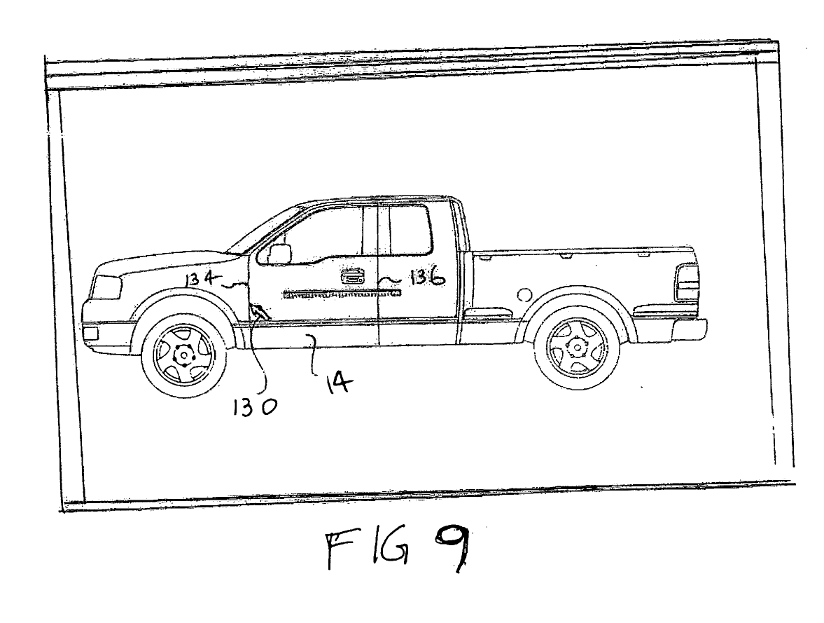

In order to establish a reference distance, the base user 4 moves the cursor 162 to a point 166, at which the end 6 of the reference marker 5 appears. The position of the point 166 is registered as by clicking on the mouse 108. As seen in FIG. 8, the end 7 of the reference marker 5 is located by moving the cursor 162 to a point 168 at the location of the end 7. The location of the point 168 is registered. The processor 110 now stores coordinates of the points 166 and 168.

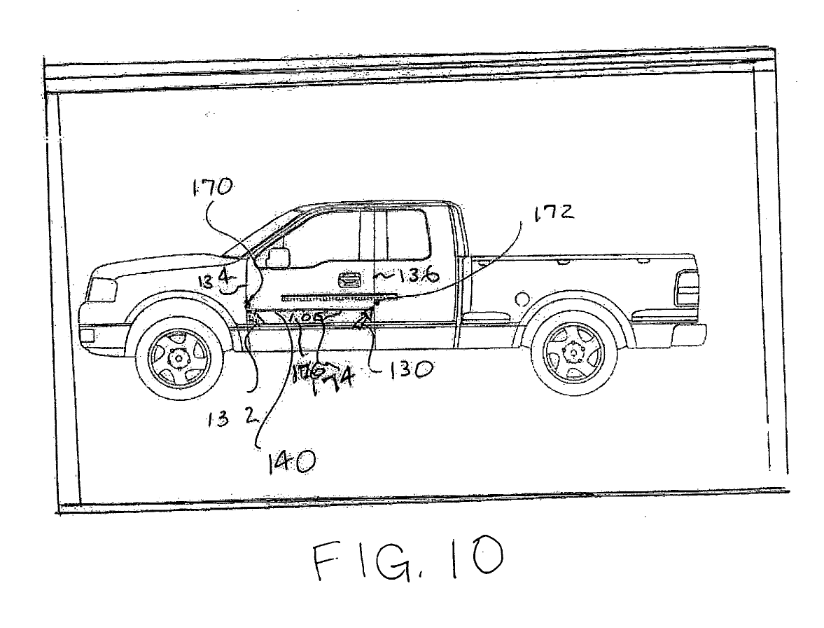

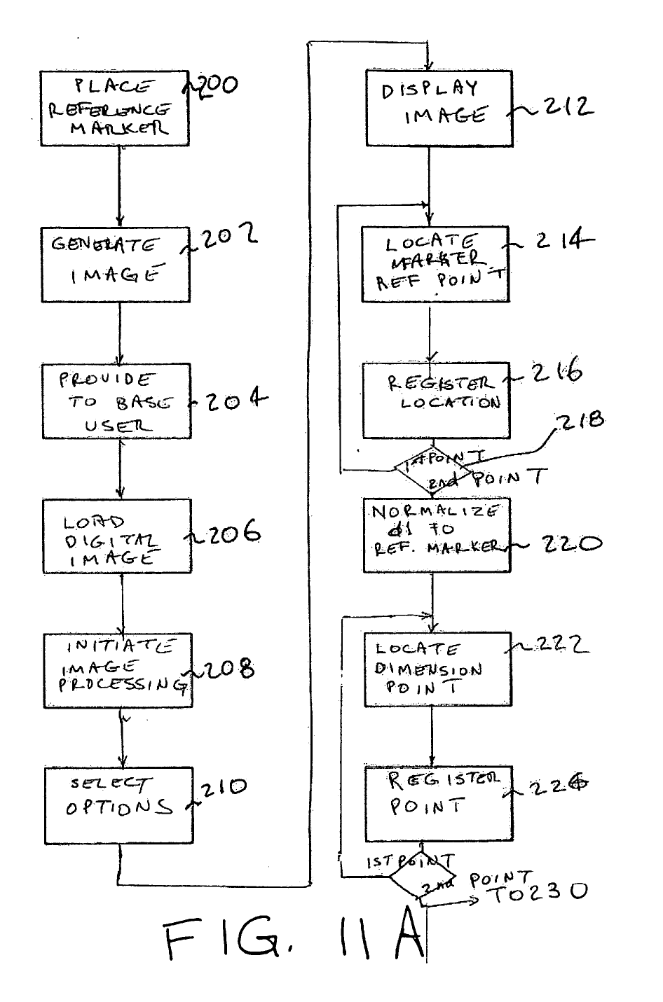

In the present illustration, the base user 4 will measure the width of the door 114. A point 170, as seen in FIG. 9, is selected at a left side of the door 14, and the base user 4 moves the cursor 162 to the point 170 and then registers the position of the point 170, as by clicking on the mouse 108. A point 172 is selected at a right side of the door 14, as seen in FIG. 10. The base user 4 moves the cursor 162 to the point 172 and registers its position. The processor 110, as further described below, draws a line segment 174 between the points 170 and 172 to display to the base user 4 the dimension that is being measured. The processor 110 calculates the length of the portion of the pickup truck 10 represented by the line segment 174. If the line 174 is not precisely parallel to a horizontal axis of the pickup truck 10, the line segment 174 may actually be longer than the width of the door 14. Any difference is minimized by the base user 4 making a careful visual estimate of the horizontal disposition of the line segment 174. In the degree of precision required for such measurement in applications such as insurance adjusting, the error will not be material. However, as indicated above with respect to FIG. 6 and below with respect to FIG. 11, a mode may be selected in which distance between points 170 and 172 only along a horizontal axis is provided. Any error introduced by the base user 4 locating the point 172 higher or lower than the point 170 is ignored.

A calculation may be made in the processor 110 of a distance d1 between the two points 166 and 168. The distance d1 is known to correspond to a reference unit, i.e., the length of the reference marker 5, e.g., one meter or one yard. Other lines segments in the image may be defined by points at opposite ends thereof, and their lengths may be similarly measured. By comparing a length d2 of another line segment in the image 160 to the distance d1, the original dimension of a corresponding line segment on the pickup truck can be calculated. The reference unit multiplied by d2/d1 is the length of the other line segment. Many different forms of calculation may be used. For example, d1 and d2 may be separately calculated and then compared. Alternatively, calculations may be made based on the coordinates of the points 166, 168, 170 and 172 without separately calculating d1 and d2. One or more indications of the length may be provided. A form may be provided which automatically has the length entered in it. For convenience of the base user 4 in the present embodiment, a number image 176 is generated and superimposed on the image 160 at a position adjacent to the line segment 174.

FIG. 11, consisting of FIGS. 11A and 11B, is a flow chart illustrating operation of the present embodiment. FIG. 11 is also illustrative of a machine-readable medium that provides instructions, which when executed by the CPU 116, cause CPU 116 to perform illustrated operations. The three digit reference numerals inserted in the following description correspond to the reference numerals denoting boxes in FIG. 11 illustrating corresponding steps. Operation begins as illustrated in FIG. 11a. The measurement process may begin, 200, with affixing a reference marker 5 (e.g., FIG. 1) to an object 3 such as the pickup truck 10. The field user 1 utilizes the digital camera 8 to generate an image of the pickup truck 10, 202. The field of view is selected by the field user 1 to include at least a potion of the pickup truck 10 of interest and the entire reference object 5 or a portion thereof having a discernable length. The image may include the entire pickup truck 10 and may further include surrounding areas.

The digital data containing image information is transmitted for use by the base user 4, 204. The transmission may be over the network 92 (FIG. 5) or may be accomplished by transporting the digital camera 8 to the workstation 100 and connecting it to the processor 110. The digital information is provided to the processor 110, 206, as by loading it into the data memory 118. An image processing program is invoked, 208, for example by the base user 4's selection of an option on the display 106. In a setup routine, 210, the base user 4 selects options such as those explained in conjunction with FIG. 6. Options include the system of units to be employed, the number of reference markers 5 in the image 160 which are each at a different distance from the digital camera 8 and whether distance along a line segment will be calculated or whether the measurement will be resolved into a measurement along an axis or axes.

The base user 4 then commands display of the image 160 on the display 106, 212. The base user 4 will locate the points on which the calculation of d1 and d2 will be based. The operation with respect to distance d1 is described first, but need not occur first. The user operates the mouse 108 to locate the point 164, 214. The mouse 108, for example, is operated to signal to the CPU 116 that current coordinates of the cursor comprise the location of one end of the image of the reference marker 5, 216. At block 218, it is noted that another point needs to be located and registered, and operation is returned to blocks 214 and 216 to locate and register the location of point 166. The coordinates thus registered may be stored in the data memory 118. The distance d1 defined by the distance between the points is calculated and set to correspond to the reference distance, 220. Alternatively, d1 may be calculated after d2 is measured.

To measure d2, the base user 4 moves the cursor 162 to point 170, 222 and registers the location of point 170, 226. At block 228, when another point needs to be located, operation is returned to block 222. Point 172 is then located and registered, 222 and 224. Coordinates may be stored in the data memory 118. Then operation proceeds from block 228 to a next step. Illustration of operation is continued in FIG. 11b.

At block 230, the processor 110 utilizes the coordinate information determined for the points 102 to generate display indicative of the line segment 174. A signal is sent to the display 106 so that the line segment 174 is displayed in the image 160. Coordinate information is accessed form the data memory 118 by the CPU 116, and d2 is calculated, 232. The value of d2 is provided to output means, 234. The output means may comprise fields in the graphical user interface 130. Also, display information is generated to provide the number image 176 displayed on the image 162 adjacent the line segment 174.

The base user 4 may repeat selected steps to provide measurements for each of a plurality of line segments 174 to characterize many dimensions within an image 162, 236. The base user 4 may also repeat selected steps to calculate dimensions in each of a number of planes, such as the planes 84, 86 and 88 of FIG. 4. The base user 4 may also provide information to clients and colleagues 238 via the network 94 or on media. The base user 4 may transmit processed images with dimensions superimposed thereon.

FIG. 12 is a flow chart illustrating a portion of operation of a further embodiment. In the embodiment of FIG. 12, the reference marker 5 is automatically resolved by image processing circuitry. In this illustration, the reference marker 5 may comprise a bright yellow rectangle. The ends 6 and 7 of the reference marker 5 are not located and registered by use of a mouse. At block 300, pixels of the image 162 are scanned. Amplitude of a signal indicative of brightness of pixels is measured, 302. Successively produced groups of pixels are compared to one another, 304. Differences in composite brightness of one group with respect to a next group are indicative of where the reference marker 5 begins and ends, 306. The locations of the ends 6 and 7 of the reference marker 5 are supplied to the CPU 116 for calculation of d1, 308. As described above, alternative means may be provided for distinguishing the reference marker 5 from the rest of an image.

Measurement of d2 may be performed as in the above-described embodiment. Alternatively, ways of marking points such as the points 170 and 172 to make them distinguishable by a scan may be used. For example, the digital camera 8 may comprise a video camera. The markers 22 and 24 may comprise blinking lights. A video digital processing may be provided in the program memory 19 that will distinguish blinking lights in an image.

The present subject matter being thus described, it will be apparent that the same may be modified or varied in many ways. Such modifications and variations are not to be regarded as a departure from the spirit and scope of the present subject matter, and all such modifications are intended to be included within the scope of the following claims.

What is claimed is:

1. A machine-readable medium that provides instructions, which when executed by a processor, cause said processor to perform operations comprising:
resolving an image of a reference marker having a predetermined length from data in a digital image;
determining an electronic length of the image of the reference marker;
normalizing an electronic length of the image of the reference marker to the predetermined length;
selecting a line segment in said image indicative of a dimension to be determined;
determining dimension data of the line segment; and
determining a length of the line segment as a function of electronic length of the image of the reference marker.

2. A machine-readable medium according to claim 1, wherein instructions to resolve an image of the reference marker comprise instructions to respond to locating a cursor at a first point and to respond to locating a cursor at a second point and establishing a reference value indicative of the distance in the image between the first and second points.

3. A machine-readable medium according to claim 1, wherein instructions to resolve an image of the reference marker comprise instructions to process the image automatically and determine location of ends of the reference marker by measuring image pixel information.

4. A machine-readable medium according to claim 2, wherein instructions to select a line segment in said image indicative of a dimension to be determined comprise instructions to respond to a location of a cursor at a first point and to respond to location of a cursor at a second point and establishing a reference value indicative of the distance in the image between the first and second points.

5. A machine-readable medium according to claim 4, wherein providing instructions to respond to selection of a point comprise instructions to register a mouse click.

6. A machine-readable medium according to claim 4, further providing instructions to produce an image of a line segment and to display the image of the line segment on said image on the dimension whose length is to be determined.

7. A machine-readable medium according to claim 4, further providing instructions to produce an image of a value of a length of the line segment and to display the image of value adjacent to the image of the line segment.

8. A machine-readable medium according to claim 4, further providing instructions to produce a graphical user interface and to permit entry of selected parameters for use in image processing.

9. A machine-readable medium according to claim 7, wherein said selected parameters include type of units in which measurements are made.

10. A machine-readable medium according to claim 31, wherein said selected parameters include an indication of a number of different reference markers included in an image.

11. A method for producing linear measurement of dimensions in a digital image comprising:
resolving an image of a reference marker having a predetermined length from data in a digital image;
normalizing an electronic length of the image of the reference marker to the predetermined length;
selecting a line segment in said image indicative of a dimension to be determined;
determining dimension data of the line segment; and
determining a length of the line segment as a function of an image of the line segment.

12. A method according to claim 11, wherein resolving an image of the reference marker comprises responding to locating a cursor at a first point and to respond to locating a cursor at a second point and establishing a reference value indicative of the distance in the image between the first and second points.

13. A method according to claim 12, wherein resolving an image of the reference marker comprises automatic image processing.

14. A method according to claim 12, wherein instructions to selecting a line segment in said image indicative of a dimension to be determined comprises responding to a locating a cursor at a first point and to respond to locating a cursor at a second point and establishing a reference value indicative of the distance in the image between the first and second points.

15. A method according to claim 14, wherein responding to locating a cursor at a point comprises registering a mouse click.

16. A method according to claim 14, further comprising displaying the image of the line segment on said image on the dimension whose length is to be determined.

17. A method medium according to claim 21, further comprising displaying an image of a value of a length of the line segment adjacent to the image of the line segment.

18. A method according to claim 20, further comprising selecting a field of view including dimensions to be measured, providing a reference marker and placing the reference marker in the field of view and taking and storing the digital image.

19. A method according to claim 20, wherein providing a reference marker comprises providing a reference marker with a high intensity color.

20. A method according to claim 18, further comprising placing a plurality of reference markers in a field of view, each at a different distance from a point at which the image is taken.

21. A linear measurement system for producing linear measurement of dimensions in a digital image comprising:
a digital image processor to provide access to a digital image;
a display to display an image including dimensions whose value is to be determined;
image interactive means to select points on the image;
storage means to store signals indicative of selected points; and
arithmetic means in said digital image processor to determine an electronic length between selected points as a function of said signals and to normalize a first electronic length between a first selected pair of points to a predetermined length and to determine a length of a dimension of an object represented by a second pair of points in the image as a function of a value of the first electronic length.

22. A linear measurement system according to claim 1 wherein said image interactive means to select points on the image comprises a computer mouse.

23. A linear measurement system according to claim 1, wherein said image interactive means to select points on the image comprises an automatic image processor.

24. A linear measurement system according to claim 1, further comprising means for receiving the image from a network.

25. A linear measurement system according to claim 1, further comprising a reference marker to be placed in a field of view comprising said image, and comprising first and second ends corresponding to said first and second points in said image.

26. A linear measurement system according to claim 5, wherein said reference marker is constructed to produce image features resolvable in image processing.
